(19) United States
(12) Patent Application Publication
(10) Pub. No.: US 2026/0267430 A1
(43) Pub. Date: Sep. 10, 2026

(54) STRAIN-BASED FORCE SENSOR MODULE IN A TOUCH-BASED ELECTRONIC DEVICE

(71) Applicant: Semtech Corporation, Camarillo, CA (US)

(72) Inventors: Omkar Padhye, San Jose, CA (US); Ilya Rosenberg, Sunnyvale, CA (US); Julius Minglin Tsai, San Jose, CA (US)

(21) Appl. No.: 19/559,447

(22) Filed: Mar. 6, 2026

Related U.S. Application Data
(60) Provisional application No. 63/850,949, filed on Jul. 25, 2025.
(60) Provisional application No. 63/767,768, filed on Mar. 6, 2025.

(51) Int. Cl. G06F 3/041

(52) U.S. Cl. CPC G06F 3/0414; G06F 2203/04103

(57) ABSTRACT

A strain-based force sensor module in a touch-based electronic device is disclosed. Herein, the strain-based force sensor module is a standalone printed circuit board (PCB) module premanufactured to integrate a strain-based force sensor(s). In an embodiment, the strain-based force sensor module can be attached to a touch interface in the touch-based electronic device without requiring such auxiliary parts as flexible printed circuits (FPC), stiffeners, and connectors. As such, it is possible to reduce the bill-of-material (BOM) and simplify the process for attaching the strain-based force sensor module onto the touch interface.

### FIELD OF THE DISCLOSURE

The technology of the disclosure relates generally to a strain-based force sensor module in a touch-based electronic device.

### BACKGROUND

Touch-based user interfaces have become increasingly common in modern electronic devices, such as smartphones, tablets, laptop computers, game controllers, automobile infotainment systems, and so on. The prevalence of the touch-based user interfaces is driven in part by advancement in touch interface (e.g., touchscreen, touchpad, trackpad, touch-sensitive button, etc.) and strain-based force sensor technologies. Herein, a strain-based force sensor is a type of sensor that measures the external force applied onto the touch interface and quantifies the external force in an electrical signal (e.g., a voltage signal).

Specifically, the phrase “strain” refers to an amount of deformation experienced by the touch interface when the external force is applied. In this regard, the strain-based force sensor typically includes a strain gauge that is attached to the touch interface. When the external force is applied onto the touch interface, the strain gauge may stretch or compress in response to the deformation experienced by the touch interface. The strain-based force sensor also includes electrical circuitry that can detect a change in electrical resistance, as caused by the deformation, and quantify the resistance change in the electrical signal, which can be further processed to determine the amount of the external force.

Conventionally, the strain-based force sensor is attached to the touch interface using a flexible printed circuit (FPC), stiffener, and connector module. As such, a bill-of-material (BOM) can increase and, accordingly, the manufacturing process for attaching the strain-based force sensor to the touch interface can become more complex. It is thus desired to reduce the BOM and simplify the manufacturing process of the touch-based user interface.

### SUMMARY

Embodiments of the disclosure relate to a strain-based force sensor module in a touch-based electronic device. Herein, the strain-based force sensor module is a standalone printed circuit board (PCB) module premanufactured to integrate a strain-based force sensor(s). In an embodiment, the strain-based force sensor module can be attached to a touch interface in the touch-based electronic device without requiring such auxiliary parts as flexible printed circuits (FPC), stiffeners, and connectors. As such, it is possible to reduce the bill-of-material (BOM) and simplify the process for attaching the strain-based force sensor module onto the touch interface.

In one aspect, a touch-based electronic device is provided. The touch-based electronic device includes a touch interface. The touch interface includes a touch substrate, and a touch surface provided on one side of the touch substrate. The touch-based electronic device also includes at least one strain-based force sensor module. The at least one strain-based force sensor module includes a PCB. The PCB has a backside attached to an opposite side of the touch substrate relative to the touch surface. The at least one strain-based force sensor module also includes a strain-based force sensor integrated circuit (IC). The strain-based force sensor IC is soldered onto a frontside of the PCB and electrically coupled to the touch surface. The strain-based force sensor IC is configured to detect a deformation of the touch interface when an external force is applied onto the touch surface. The strain-based force sensor IC is also configured to generate an electrical signal quantifying the deformation of the touch interface.

In another aspect, a method for providing a strain-based force sensor module in a touch-based electronic device is provided. The method includes assembling a touch interface comprising a touch substrate and a touch surface provided on one side of the touch substrate. The method also includes preassembling at least one strain-based force sensor module to include a PCB having a frontside and a backside and a strain-based force sensor IC soldered onto the frontside of the PCB and electrically coupled to the touch surface. The method also includes attaching the backside of the PCB to an opposite side of the touch substrate relative to the touch surface such that the at least one strain-based force sensor module can detect a deformation of the touch interface when an external force is applied onto the touch surface and generate an electrical signal quantifying the deformation of the touch interface.

In another aspect, a wireless device is provided. The wireless device includes a touch interface. The touch interface includes a touch substrate, and a touch surface provided on one side of the touch substrate. The wireless device also includes at least one strain-based force sensor module. The at least one strain-based force sensor module includes a PCB. The PCB has a backside attached to an opposite side of the touch substrate relative to the touch surface. The at least one strain-based force sensor module also includes a strain-based force sensor IC. The strain-based force sensor IC is soldered onto a frontside of the PCB and electrically coupled to the touch surface. The strain-based force sensor IC is configured to detect a deformation of the touch interface when an external force is applied onto the touch surface. The strain-based force sensor IC is also configured to generate an electrical signal quantifying the deformation of the touch interface.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic diagram of an exemplary strain-based force sensor module assembled according to an embodiment of the present disclosure;

FIGS. 2A-2B are schematic diagrams providing exemplary illustrations as to how the strain-based force sensor module of FIG. 1 can be attached to a touch interface;

FIGS. 3A-3C are schematic diagrams illustrating how the strain-based force sensor module of FIG. 1 can be provided in a touch-based electronic device;

FIG. 4 is a schematic diagram of an exemplary communication device wherein the strain-based force sensor module of FIG. 1 can be provided; and

FIG. 5 is a flowchart of an exemplary process for providing the strain-based force sensor module of FIG. 1 in the touch-based electronic device of FIGS. 3A-3C.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term "and/or" includes any and all combinations of one or more of the associated listed items.

It will be understood that when an element such as a layer, region, or substrate is referred to as being "on" or extending "onto" another element, it can be directly on or extend directly onto the other element or intervening elements may also be present. In contrast, when an element is referred to as being "directly on" or extending "directly onto" another element, there are no intervening elements present. Likewise, it will be understood that when an element such as a layer, region, or substrate is referred to as being "over" or extending "over" another element, it can be directly over or extend directly over the other element or intervening elements may also be present. In contrast, when an element is referred to as being "directly over" or extending "directly over" another element, there are no intervening elements present. It will also be understood that when an element is referred to as being "connected" or "coupled" to another element, it can be directly connected or coupled to the other element or intervening elements may be present. In contrast, when an element is referred to as being "directly connected" or "directly coupled" to another element, there are no intervening elements present.

Relative terms such as "below" or "above" or "upper" or "lower" or "horizontal" or "vertical" may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms "a," "an," and "the" are intended to include the plural forms as well, unless the context clearly indicates otherwise. It will be further understood that the terms "comprises," "comprising," "includes," and/or "including" when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments of the disclosure relate to a strain-based force sensor module in a touch-based electronic device. Herein, the strain-based force sensor module is a standalone printed circuit board (PCB) module premanufactured to integrate a strain-based force sensor(s). In an embodiment, the strain-based force sensor module can be attached to a touch interface in the touch-based electronic device without requiring such auxiliary parts as flexible printed circuits (FPC), stiffeners, and connectors. As such, it is possible to reduce the bill-of-material (BOM) and simplify the process for attaching the strain-based force sensor module onto the touch interface.

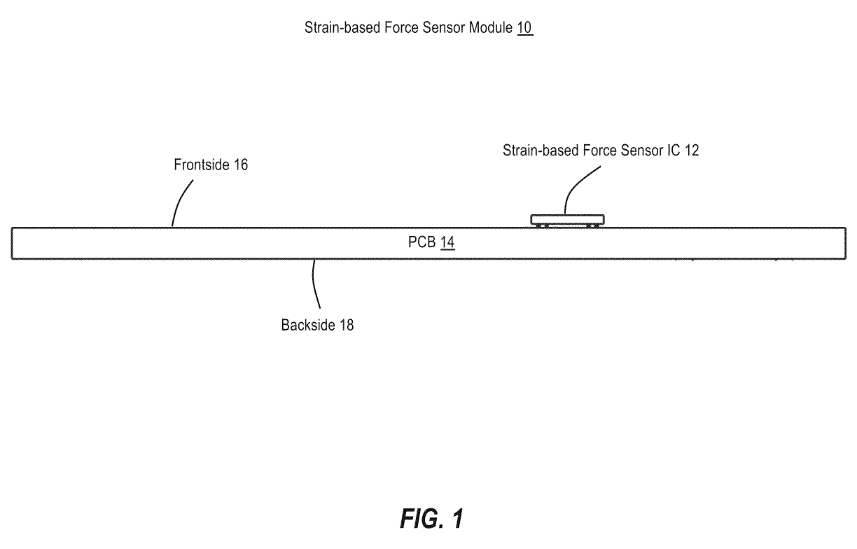

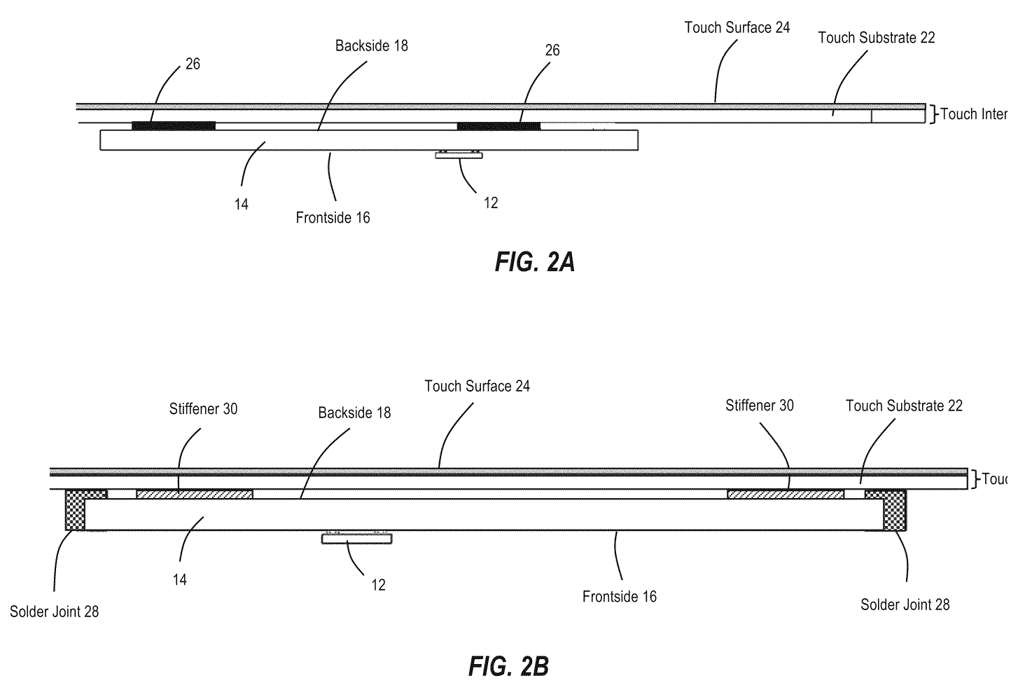

FIG. 1 is a schematic diagram of an exemplary strain-based force sensor module 10 assembled according to an embodiment of the present disclosure. Herein, the strain-based force sensor module 10 includes at least one strain-based force sensor integrated circuit (IC) 12 and a PCB 14. In an embodiment, the strain-based force sensor IC can include multiple (e.g., four) strain-based force sensors (not shown). The PCB 14 has a frontside 16 and a backside 18. In an embodiment, the strain-based force sensor IC 12 is soldered onto the frontside 16 of the PCB 14. As further discussed in FIGS. 2A and 2B, by preassembling the strain-based force sensor module 10 as a standalone module, it is possible to reduce the auxiliary parts and assembly time required for mounting the strain-based force sensor module 10 onto a touch interface, thus helping to reduce overall BOM costs and eliminate potential blind touch spots on the touch interface.

FIGS. 2A-2B are schematic diagrams providing exemplary illustrations as to how the strain-based force sensor module 10 of FIG. 1 can be attached to a touch interface 20. Common elements between FIGS. 1 and 2A-2B are shown therein with common element numbers and will not be re-described herein.

FIG. 2A illustrates how the strain-based force sensor module 10 of FIG. 1 can be attached to the touch interface 20 according to one embodiment of the present disclosure. Herein, the touch interface 20 includes a touch substrate 22 and a touch surface 24 provided on one side of the touch substrate 22. The backside 18 of the PCB 14 is attached to the touch substrate 22 via a pair of copper pads 26. As illustrated herein, the strain-based force sensor module 10 is attached to an opposite side of the touch substrate 22 relative to the touch surface 24. By attaching the strain-based force sensor module 10 to the touch interface 20 using the copper pads 26, it is possible to eliminate such auxiliary parts as FPCs, stiffeners, and connectors to thereby reduce the BOM cost. Moreover, the copper pads 26 can electrically connect the strain-based force sensor IC 12 to the touch interface 20. In an embodiment, the strain-based force sensor IC 12 should be mounted on the PCB 14 at a location that is vertically aligned with (e.g., directly on top of, overlapped with, or at least in close proximity to) the copper pads 26 across the PCB 14 such that the copper pads 26 can provide rigid support to the strain-based force sensor module 10.

FIG. 2B illustrates how the strain-based force sensor module 10 of FIG. 1 can be attached to the touch interface 20 according to another embodiment of the present disclosure. Herein, the backside 18 of the PCB 14 is attached to the opposite side of the touch interface 20 relative to the touch surface 24 via a pair of solder joints 28. The solder joints 28 can electrically couple the strain-based force sensor IC 12 to the touch interface 20. One or more stiffeners 30 may be provided between the backside 18 of the PCB 14 and the touch substrate 22 to enhance support for the strain-based force sensor module 10.

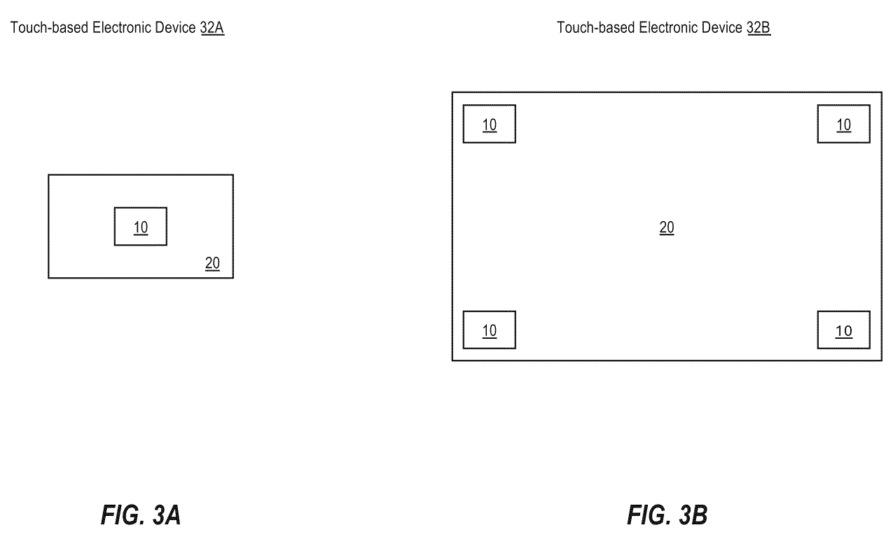

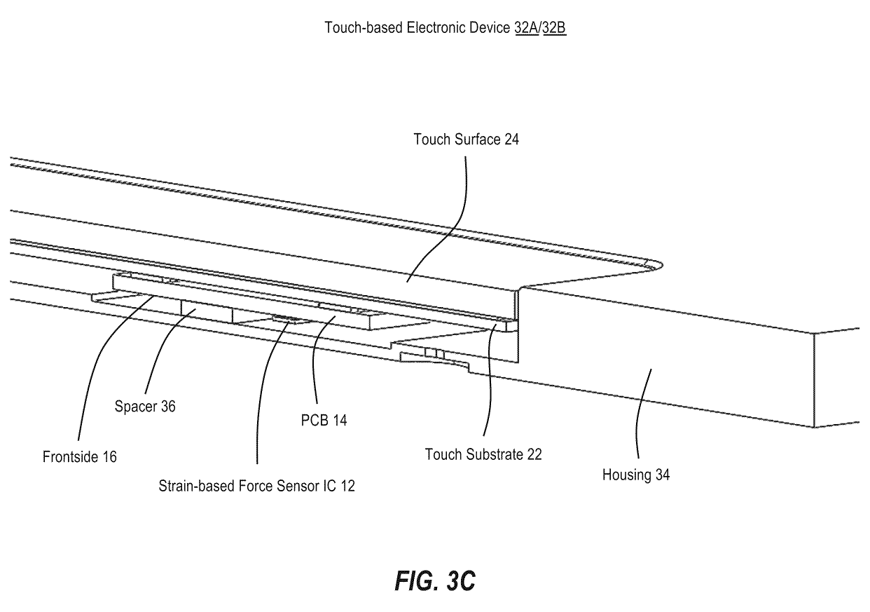

Depending on specific applications, a touch-based electronic device, such as a smartphone, tablet, laptop computer, game controller, and automobile infotainment system, can employe an appropriate number of the strain-based force sensor module 10 of FIG. 1 to help improve touch experiences and eliminate potential blind touch spots on a touch-based user interface. In one embodiment, FIG. 3A illustrates a touch-based electronic device 32A (e.g., a game controller) wherein only one strain-based force sensor module 10 is needed to support the touch interface 20 of a smaller sized device. In another embodiment, FIG. 3B illustrates a touch-based electronic device 32B (e.g., a laptop computer) wherein four strain-based force sensor modules 10 are needed to support the touch interface 20 of a larger sized device. As an example, the strain-based force sensor modules 10 are provided in proximity to the four corners of the touch interface 20 to help eliminate potential blind touch spots on the touch interface 20. Understandably, any additional numbers of the strain-based force sensor module 10 may be added in the touch-based electronic device 32A and/or the touch-based electronic device 32B as needed.

FIG. 3C is a schematic diagram providing an exemplary illustration as to how the strain-based force sensor module 10 can be provided in the touch-based electronic device 32A of FIG. 3A and the touch-based electronic device 32B of FIG. 3B. Common elements between FIGS. 1, 2A-2B, and 3A-3C are shown therein with common element numbers and will not be re-described herein.

In an embodiment, the strain-based force sensor module 10 can be enclosed in a housing 34 that encompasses the touch substrate 22 and the touch surface 24. A spacer 36 (e.g., silicon rubber) is placed between the frontside 16 of the PCB 14 and the housing 34. In a non-limiting example, the spacer 36 should be smaller than the PCB 14 and have a thickness of approximately 0.5 to 1 millimeter. Herein, the spacer 36 can act as a force transfer mechanism to allow the strain-based force sensor module 10 to expand or compress when an external force is applied onto the touch surface 24. Accordingly, the strain-based force sensor IC 12 can detect the deformation of the strain-based force sensor module 10 and quantify the amount of external force in an electrical signal (e.g., a voltage signal).

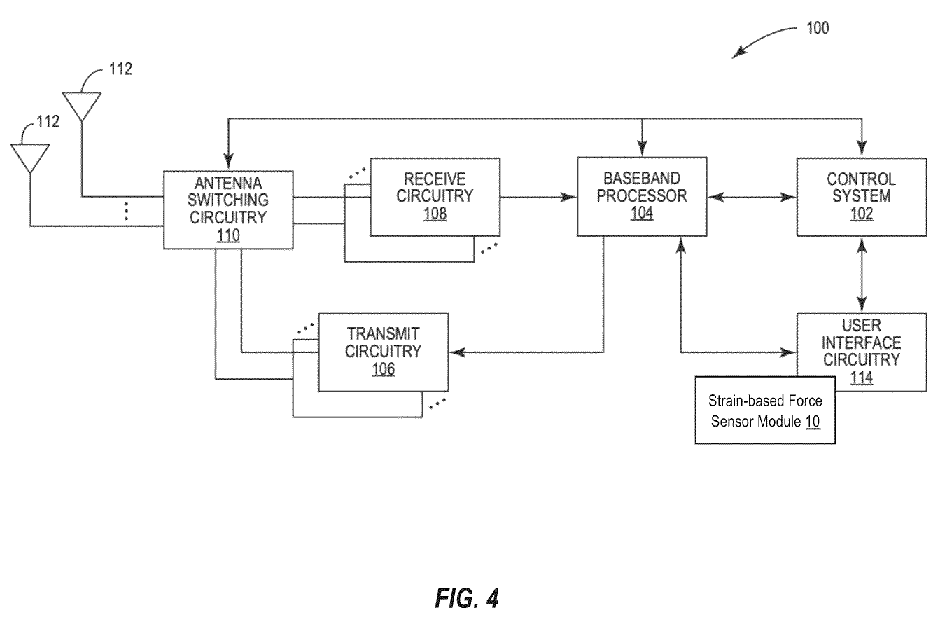

In a non-limiting example, the strain-based force sensor module 10 can also be provided in a touch-based wireless communication device. In this regard, FIG. 4 is a schematic diagram of an exemplary communication device 100 wherein the strain-based force sensor module 10 of FIG. 1 can be provided.

Herein, the communication device 100 can be any type of communication device, such as a mobile terminal, smart watch, tablet, computer, navigation device, access point, base station (e.g., eNB, gNB, etc.), and any other type of wireless communication device that support wireless communications, such as cellular, wireless local area network (WLAN), Bluetooth, Ultra-wideband (UWB), and near field communications. The communication device 100 will generally include a control system 102, a baseband processor 104, transmit circuitry 106, receive circuitry 108, antenna switching circuitry 110, multiple antennas 112, and user interface circuitry 114. In an embodiment, the strain-based force sensor module 10 of FIG. 1 can be provided in the user interface circuitry 114.

In a non-limiting example, the control system 102 can be a field-programmable gate array (FPGA), as an example. In this regard, the control system 102 can include at least a microprocessor(s), an embedded memory circuit(s), and a communication bus interface(s). The receive circuitry 108 receives radio frequency signals via the antennas 112 and through the antenna switching circuitry 110 from one or more base stations. A low noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using an analog-to-digital converter(s) (ADC).

The baseband processor 104 processes the digitized received signal to extract the information or data bits conveyed in the received signal. This processing typically comprises demodulation, decoding, and error correction operations, as will be discussed in greater detail below. The baseband processor 104 is generally implemented in one or more digital signal processors (DSPs) and application specific integrated circuits (ASICs).

For transmission, the baseband processor 104 receives digitized data, which may represent voice, data, or control information, from the control system 102, which it encodes for transmission. The encoded data is output to the transmit circuitry 106, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission, and deliver the modulated carrier signal to the antennas 112 through the antenna switching circuitry 110. The multiple antennas 112 and the replicated transmit and receive circuitries 106, 108 may provide spatial diversity. Modulation and processing details will be understood by those skilled in the art.

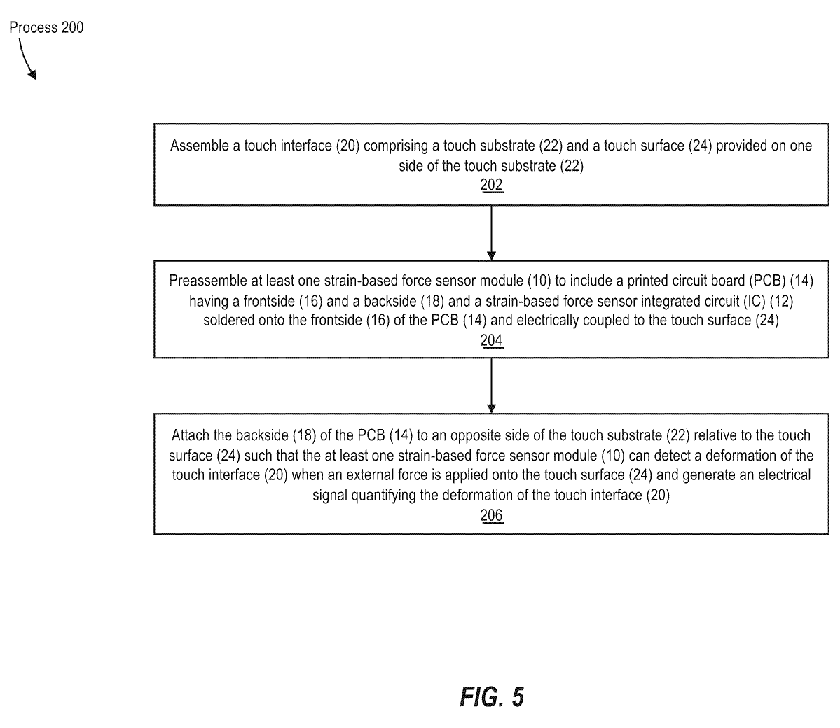

In an embodiment, the strain-based force sensor module 10 can be provided in the touch-based electronic device 32A of FIG. 3A and the touch-based electronic device 32B of FIG. 3B according to a process. In this regard, FIG. 5 is a flowchart of an exemplary process 200 for providing the strain-based force sensor module 10 in the touch-based electronic device 32A of FIG. 3A and the touch-based electronic device 32B of FIG. 3B.

Herein, the process 200 includes assembling the touch interface 20 comprising the touch substrate 22 and the touch surface 24 provided on one side of the touch substrate 22 (step 202). The process 200 also includes preassembling the strain-based force sensor module 10 to include the PCB 14 having the frontside 16 and the backside 18 and the strain-based force sensor IC 12 soldered onto the frontside 16 of the PCB 14 and electrically coupled to the touch surface 24 (step 204). The process 200 also includes attaching the backside 18 of the PCB 14 to an opposite side of the touch substrate 22 relative to the touch surface 24 such that the strain-based force sensor module 10 can detect the deformation of the touch interface 20 when the external force is applied onto the touch surface 24 and generate the electrical signal quantifying the deformation of the touch screen 20 (step 206).

Those skilled in the art will recognize improvements and modifications to the preferred embodiments of the present disclosure. All such improvements and modifications are considered within the scope of the concepts disclosed herein and the claims that follow.

What is claimed is:

1. A touch-based electronic device comprising:
a touch interface comprising a touch substrate and a touch surface provided on one side of the touch substrate; and
at least one strain-based force sensor module comprising:
a printed circuit board (PCB) having a backside attached to an opposite side of the touch substrate relative to the touch surface; and
a strain-based force sensor integrated circuit (IC) soldered onto a frontside of the PCB and electrically coupled to the touch surface, the strain-based force sensor IC is configured to:
detect a deformation of the touch interface when an external force is applied onto the touch surface; and
generate an electrical signal quantifying the deformation of the touch interface.

2. The touch-based electronic device of claim 1, wherein the strain-based force sensor IC comprises a plurality of strain-based force sensors.

3. The touch-based electronic device of claim 1, wherein the backside of the PCB is attached to the touch substrate via a pair of copper pads that electrically couple the strain-based force sensor IC to the touch surface.

4. The touch-based electronic device of claim 3, wherein at least one of the pair of copper pads is vertically aligned with the strain-based force sensor IC to thereby provide rigid support for the strain-based force sensor IC.

5. The touch-based electronic device of claim 1, wherein the backside of the PCB is attached to the touch substrate via a pair of solder joints that electrically couple the strain-based force sensor IC to the touch surface.

6. The touch-based electronic device of claim 5, further comprising one or more stiffeners provided between the backside of the PCB and the touch substrate to enhance support for the at least one strain-based force sensor module.

7. The touch-based electronic device of claim 1, wherein the at least one strain-based force sensor module is enclosed in a housing that encompasses the touch interface.

8. The touch-based electronic device of claim 7, wherein a spacer is provided between the housing and the frontside of the PCB to act as a force transfer mechanism.

9. The touch-based electronic device of claim 8, wherein the spacer has a smaller area than the PCB and a thickness between one-half millimeter and one millimeter.

10. A method for providing a strain-based force sensor module in a touch-based electronic device comprising:
assembling a touch interface comprising a touch substrate and a touch surface provided on one side of the touch substrate;
preassembling at least one strain-based force sensor module to include a printed circuit board (PCB) having a frontside and a backside and a strain-based force sensor integrated circuit (IC) soldered onto the frontside of the PCB and electrically coupled to the touch surface; and
attaching the backside of the PCB to an opposite side of the touch substrate relative to the touch surface such that the at least one strain-based force sensor module can detect a deformation of the touch interface when an external force is applied onto the touch surface and generate an electrical signal quantifying the deformation of the touch interface.

11. The method of claim 10, further comprising providing a plurality of strain-based force sensors in the strain-based force sensor IC.

12. The method of claim 10, further comprising attaching the backside of the PCB to the touch substrate via a pair of copper pads that electrically couple the strain-based force sensor IC to the touch surface.

13. The method of claim 12, further comprising vertically aligning the strain-based force sensor IC with at least one of the pair of copper pads.

14. The method of claim 10, further comprising attaching the backside of the PCB to the touch substrate via a pair of solder joints that electrically couple the strain-based force sensor IC to the touch surface.

15. The method of claim 14, further comprising providing one or more stiffeners between the backside of the PCB and the touch substrate to enhance support for the strain-based force sensor module.

16. The method of claim 10, further comprising enclosing the strain-based force sensor module in a housing that encompasses the touch interface.

17. The method of claim 16, further comprising providing a spacer between the housing and the frontside of the PCB to act as a force transfer mechanism.

18. A wireless device comprising:
a touch interface comprising a touch substrate and a touch surface provided on one side of the touch substrate; and
at least one strain-based force sensor module comprising:
a printed circuit board (PCB) having a backside attached to an opposite side of the touch substrate relative to the touch surface; and
a strain-based force sensor integrated circuit (IC) soldered onto a frontside of the PCB and electrically coupled to the touch surface, the strain-based force sensor IC is configured to:
detect a deformation of the touch interface when an external force is applied onto the touch surface; and
generate an electrical signal quantifying the deformation of the touch interface.
